(19) United States
(12) Patent Application Publication
(10) Pub. No.: US 2017/0023516 A1
(43) Pub. Date: Jan. 26, 2017

(54) HAND-HELD TEST METER WITH FLUID INGRESS DETECTION CIRCUIT

(71) Applicant: LifeScan Scotland Limited, Inverness (GB)

(72) Inventor: Malcolm D. HAMER, Inverness (GB)

(21) Appl. No.: 14/806,093

(22) Filed: Jul. 22, 2015

(51) Int. Cl. G01N 27/327

(52) U.S. Cl. CPC G01N 27/3273; G01N 27/3272; G01N 27/3274

(57) ABSTRACT

A hand-held test meter (“HHTM”) for use with analytical test strip in the determination of an analyte in a bodily fluid sample includes a housing, a strip port connector disposed at least partially within the housing, a micro-controller disposed in the housing, a voltage supply disposed in the housing, a fluid ingress detection circuit block (“FRIDCB”) disposed in the housing and includes a paired signal and ground trace, and a ground-reference. A portion of the signal trace and ground trace are separated by a predetermined distance. The signal trace is electrically connected to the voltage supply and to the micro-controller and the ground trace is electrically connected to the ground-reference. With no ingress fluid, the signal trace is electrically isolated from the ground trace. The FRIDCB generates an output signal to the micro-controller that is dependent on fluid ingress into the meter housing, thus providing for detection of fluid ingress.

### BACKGROUND OF THE INVENTION

Field of the Invention

The present invention relates, in general, to medical devices and, in particular, to hand-held test meters and related methods.

Description of Related Art

The determination (e.g., detection and/or concentration measurement) of an analyte in, or characteristic of, a bodily fluid sample is of particular interest in the medical field. For example, it can be desirable to determine glucose, ketone bodies, cholesterol, lipoproteins, triglycerides, acetaminophen, haematocrit and/or HbA1c concentrations in a sample of a bodily fluid such as urine, blood, plasma or interstitial fluid. Such determinations can be achieved using a hand-held test meter in combination with analytical test strips (e.g., electrochemical-based analytical test strips).

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings, in which like numerals indicate like elements, of which:

FIG. 1 is a simplified depiction of a hand-held test meter according to an embodiment of the present invention with a test strip (TS) inserted therein;

FIG. 2 is a simplified block diagram of various blocks of the hand-held test meter of FIG. 1 as well as an inserted test strip (TS);

FIG. 3 is another simplified depiction of a portion of the hand-held test meter of FIG. 1 illustrating a fluid ingress detection circuit block disposed in the vicinity of a strip port connector (SPC) of the hand-held test meter;

FIG. 4 is a simplified electrical schematic of a fluid ingress detection circuit block as can be employed in embodiments of the present invention;

FIGS. 5A and 5B are simplified electrical schematics of a portion of a fluid ingress detection circuit block and related circuit block current equations in the absence of fluid (FIG. 5A) and in the presence of fluid ingress (FIG. 5B) as can be employed in embodiments of the present invention; and

FIG. 6 is a flow diagram depicting stages in a method for operating a hand-held test meter according to an embodiment of the present invention.

### DETAILED DESCRIPTION OF ILLUSTRATIVE EMBODIMENTS

The following detailed description should be read with reference to the drawings, in which like elements in different drawings are identically numbered. The drawings, which are not necessarily to scale, depict exemplary embodiments for the purpose of explanation only and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein.

In general, hand-held test meters for use with an analytical test strip (e.g., an electrochemical-based analytical test strip) in the determination of an analyte (such as glucose) in a bodily fluid sample (such as for example, a whole blood sample) according to embodiments of the present invention include a housing, a strip port connector disposed at least partially within the housing, a micro-controller disposed in the housing, a voltage supply disposed in the housing (e.g., a 3V voltage supply), and a fluid ingress detection circuit block disposed in the housing that includes at least one paired signal trace and ground trace, and a ground-reference.

In hand-held test meter according to embodiments of the present invention, a portion of the paired signal trace and ground trace are separated by a predetermined distance (for example, a distance of 1 mm or less). In addition, the signal trace is electrically connected to the voltage supply and to the micro-controller and the ground trace is electrically connected to the ground-reference. Moreover, in the absence of ingress fluid, the signal trace is electrically isolated from the ground trace. In such a configuration, the fluid ingress detection circuit block generates an output signal to the micro-controller that is dependent on fluid ingress into the meter housing, thus providing for detection of fluid ingress.

Once apprised of the present disclosure, one skilled in the art will recognize that the term “paired” as used with respect to the paired signal trace and ground trace refers to a signal trace and ground trace that operate in concert to signal the detection of fluid ingress when such fluid forms a conducting bridge between the signal trace and the ground trace.

The ingress of fluids, such as water and cleaning solutions, into a hand-held test meter's housing can damage electrical components therein, create electrical leakage paths that drain batteries within the hand-held test meter and potentially lead over the course of time to the generation of inaccurate analyte determinations. Hand-held test meters according to embodiments of the present invention are beneficial in that the fluid ingress detection circuit block is configured to generate an output signal that varies with the presence or absence of fluid ingress. Such an output signal can be monitored by, for example, the micro-controller and a warning message displayed to a user when fluid ingress has been detected.

In addition, fluid ingress detection circuit blocks employed in embodiments of inventions according to the present invention cost effective in that they can include only relatively inexpensive components (for example, signal traces, ground traces and a low cost resistor).

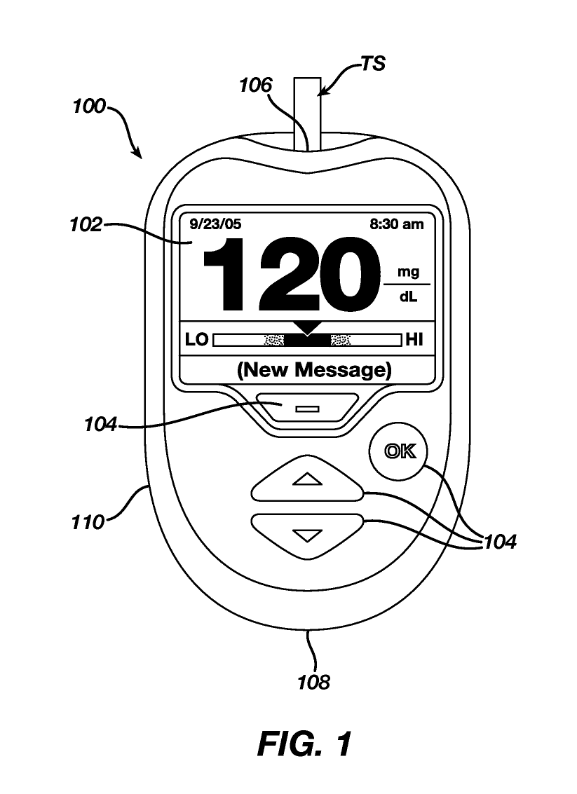

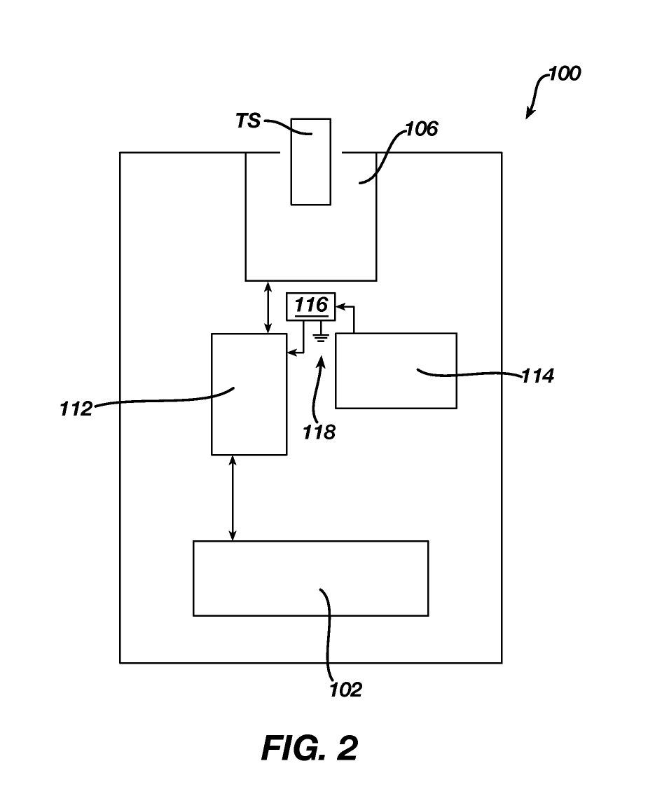

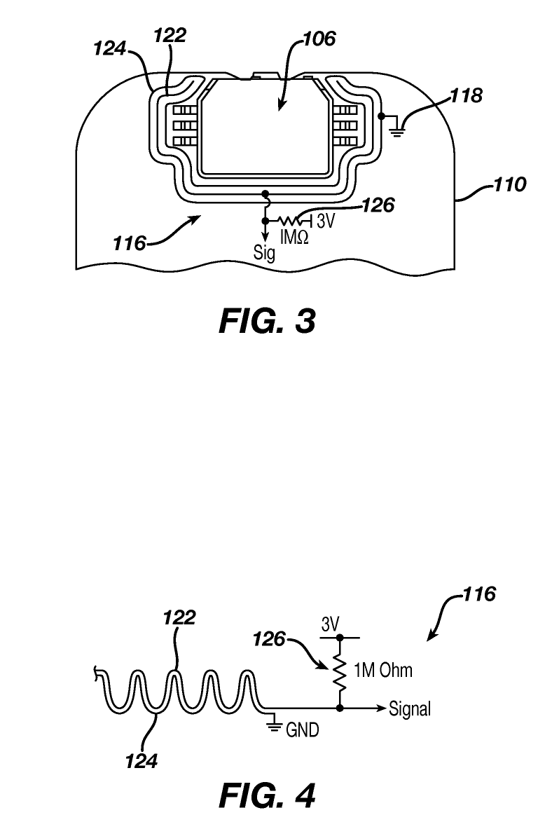

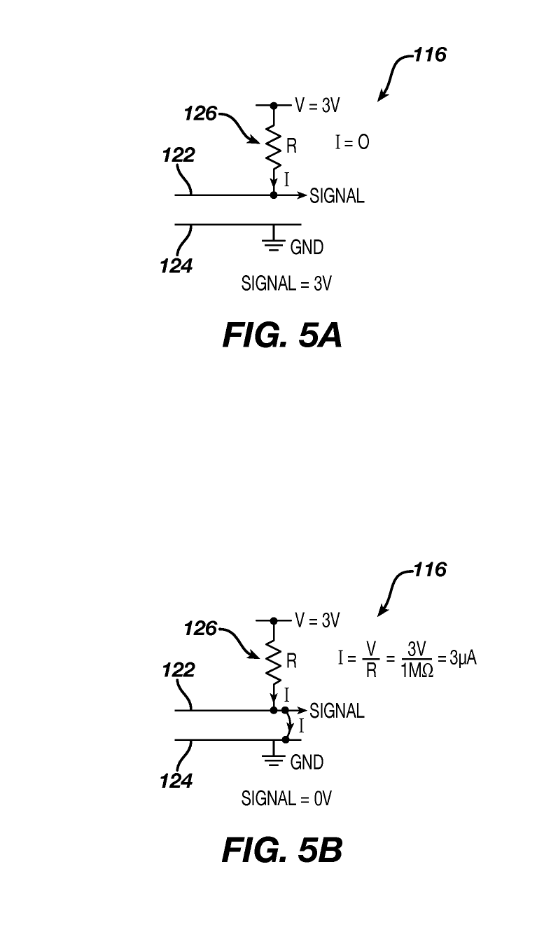

FIG. 1 is a simplified depiction of a hand-held test meter 100 for the determination of an analyte in, and/or a characteristic of, a bodily fluid sample according to an embodiment of the present invention. FIG. 2 is a simplified block diagram of various blocks of hand-held test meter 100 and a test strip (TS). FIG. 3 is a simplified depiction of a portion of the hand-held test meter of FIG. 1 illustrating a fluid ingress detection circuit block disposed in the vicinity of a strip port connector (SPC) of hand-held test meter 100. FIG. 4 is a simplified electrical schematic of a fluid ingress detection circuit block as can be employed in embodiments of the present invention including hand-held test meter 100. FIGS. 5A and 5B are simplified electrical schematics of a portion of a fluid ingress detection circuit block and related circuit block current equations in the absence of fluid (FIG. 5A) and in the presence of fluid ingress (FIG. 5B) as can be employed in embodiments of the present invention including hand-held test meter 100.

Referring to FIGS. 1 through 5B, hand-held test meter 100 includes a display 102, a plurality of user interface buttons 104, a strip port connector 106, a USB interface 108, and a housing 110 (see FIG. 1). Referring to FIG. 2 in particular, hand-held test meter 100 also includes a micro-controller block 112, a voltage supply 114, fluid ingress detection circuit block 116, a ground reference 118 and other electronic components (not shown in the FIGs.) for applying an electrical bias (e.g., an alternating current (AC) and/or direct current (DC) bias) to an electrochemical-based analytical test strip (labeled TS in FIG. 1), and also for measuring an electrochemical response (e.g., plurality of test current values, phase, and/or magnitude) and determining an analyte or characteristic based on the electrochemical response. To simplify the current descriptions, the figures do not depict all such electronic circuitry.

Display 102 can be, for example, a liquid crystal display or a bi-stable display configured to show a screen image. An example of a screen image during the determination of an analyte in a bodily fluid sample may include a glucose concentration, a date and time, an error message, and a user interface for instructing a user how to perform a test. Examples of screen images during use of the operating range test strip simulation circuit block may be an image reporting that a hand-held test meter operating range test passed, or an image reporting that the hand-held test meter operating range test has resulted in an error.

Strip port connector 106 is configured to operatively interface with an electrochemical-based analytical test strip TS, such as an electrochemical-based analytical test strip configured for the determination of hematocrit and/or glucose in a whole blood sample. Therefore, the electrochemical-based analytical test strip is configured for operative insertion into strip port connector 106 and to operatively interface with micro-controller block 112 via, for example, suitable electrical contacts, wires, electrical interconnects or other structures known to one skilled in the art.

USB Interface 108 can be any suitable interface known to one skilled in the art. USB Interface 108 is an electrical component that is configured to power and provide a data line to hand-held test meter 100.

Micro-controller block 112 also includes a memory sub-block that stores suitable algorithms for the determination of an analyte based on the electrochemical response of an analytical test strip and to also determine a characteristic (e.g., hematocrit) of the introduced bodily fluid sample. Micro-controller block 112 is disposed within housing 110 and can include any suitable micro-controller and/or micro-processer known to those skilled in the art. Suitable micro-controllers include, but are not limited to, micro-controllers available commercially from Texas Instruments (Dallas, Tex., USA) under the MSP430 series of part numbers; from ST MicroElectronics (Geneva, Switzerland) under the STM32F and STM32L series of part numbers; and Atmel Corporation (San Jose, Calif., USA) under the SAM4L series of part numbers). Micro-controller block 112 is in communication with fluid ingress detection circuit 116 via, for example, a digital input port of micro-controller block 112 that is configured to receive an output signal from fluid ingress detection circuit block 116. Such as signal is denoted by an arrow in FIG. 2, and by the label “Signal” in FIGS. 3 and 4 and by the label “SIGNAL” in FIGS. 5A and 5B. However, once apprised of the present disclosure, one skilled in the art will recognize that the input from fluid ingress detection circuit block 116 to micro-controller block 112 can also be an analog input.

Ground reference 118 of hand-held test meter 100 can be any suitable meter ground reference known to one skilled in the art. For example, a meter ground-reference can be a ground reference employed by the hand-held test meter's power supply such as a battery's negative terminal.

Referring, in particular, to FIGS. 3, 4, 5A and 5B, fluid ingress detection circuit block 116 includes at least one paired signal trace 122 and ground trace 124. Signal trace 122 is electrically connected to voltage supply 114 (e.g. a 3V voltage supply as notated in FIGS. 3, 4, 5A and 5B). Ground trace 124 is electrically connected to ground reference 118. It should be noted that at least a portion of ground trace 124 and signal trace 122 are separated by a predetermined distance (e.g., a distance of less than 1 mm) such that fluid ingress into housing 110 bridges the distance between the ground trace and the signal trace to create an electrical short circuit therebetween (compare FIG. 5A and FIG. 5B).

In the embodiment of FIGS. 3, 4, 5A and 5B, fluid ingress detection circuit block 116 includes a resistor 126. Resistor 126 can be any suitable resistor such as a 1 M-ohm resistor available commercially from Vishay as part number CRCW04021M00FKED.

In the absence of fluid ingress that bridges signal trace 122 and ground trace 124, the output signal from fluid ingress detection circuit block 116 is, for example, a first predetermined value such as 3V (see FIG. 5A where a 3V signal applied to signal trace 122 results in a 3V SIGNAL). In the presence of fluid ingress, the output signal from fluid ingress detection circuit block 116 is a second predetermined value such as essentially 0 V (see FIG. 5B). The configuration of FIGS. 5A and 5B is particularly beneficial since, in the absence of fluid ingress, there is no current flowing on the circuit (see FIG. 5A) and thus no deleterious draining of batter power.

The paired signal trace 122 and ground trace 124 can be formed using any suitable technique including, for example, being formed on a printed circuit board (PCB) disposed within housing 110. Signal trace 122 and ground trace 124 can be, for example, formed of electro less nickel with gold plating. Moreover, paired signal and ground traces employed in embodiments of the present invention can be disposed within hand-held test meter housing in any suitable configuration and are not limited to the configurations depicted in FIGS. 3 and 4.

Once apprised of the present disclosure, one skilled in the art will recognize that fluid ingress detection circuit blocks employed in embodiments of the present invention can take various forms and are not limited to the embodiment depicted in FIGS. 3, 4, 5A and 5B. For example, suitable fluid ingress detection circuit block can include (i) a paired signal trace and ground trace in operable communication with suitably configured operational amplifier(s) that provides for the detection of an electrical short circuit between the signal trace and the ground trace or (ii) a paired signal trace and ground trace combined with any suitable electrical circuit that can detect an electrical short circuit between the signal trace and the ground trace.

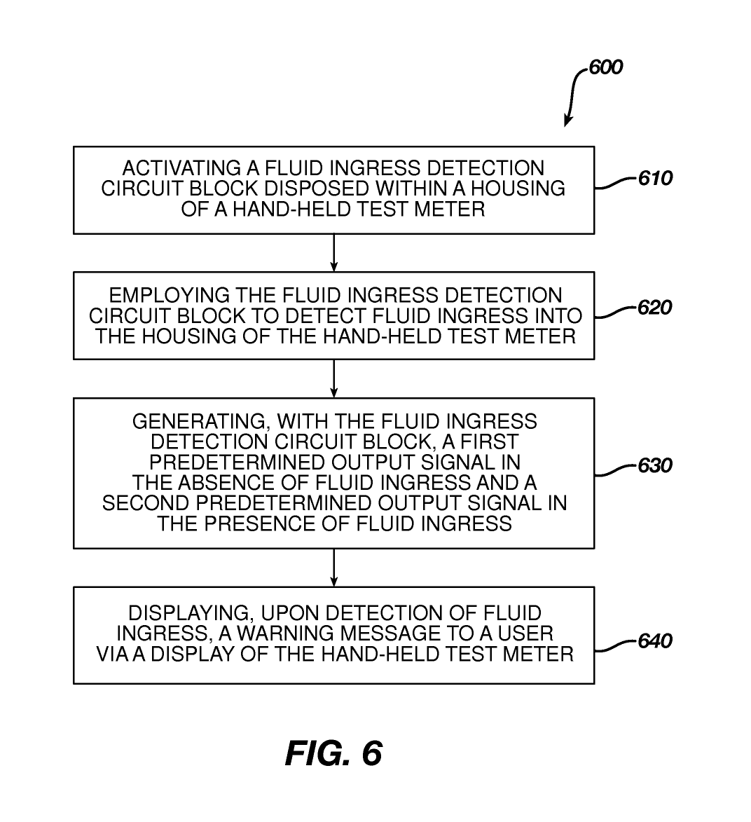

FIG. 6 is a flow diagram depicting stages in a method 600 for employing a hand-held test meter (e.g., hand-held test meter 100 of FIG. 1) for use with an analytical test strip for the determination of an analyte in, and/or a characteristic of, a bodily fluid sample (e.g., a whole blood sample), according to an embodiment of the present invention. A non-limiting example of such an analyte is glucose in a whole blood sample. A non-limiting example of such a characteristic is hematocrit of a whole blood sample. A non-limiting example of such an analytical test strip is an electrochemical-based analytical test strip.

Method 600 includes, at step 610, activating a fluid ingress detection circuit block disposed within a housing of the hand-held test meter. Such activation can involve, for example, powering on the hand-held test meter and/or activation of a predetermined step in software controlling the hand-held test meter. The activated fluid ingress detection circuit block can be, for example, the fluid circuit detection block described herein with respect to hand-held test meter 100 or described herein with respect to any other embodiment of the present hand-held test meter invention.

At step 610, the fluid ingress detection circuit block of the hand-held test meter is employed to detect the presence of fluid ingress into the housing of the hand-held test meter. Such detection step can, for example, include applying a predetermined voltage to a signal trace of a paired signal and ground trace of the fluid ingress detection circuit block. An example of such application is depicted in, and described with respect to, FIGS. 5A and 5B.

Step 620 results in the fluid ingress detection circuit block generating an output signal (see step 630). In step 630, the output signal is a first predetermined output signal in the absence of fluid ingress (see, for example, the 3V output signal depicted in FIG. 5A) and a second predetermined output signal in the presence of fluid ingress (see, for example, the 0 V output signal depicted in FIG. 5B). In step 630, the second predetermined output signal represents detection of ingress fluid.

If desired, detection of fluid ingress via steps 610, 620 and 630 can be employed to display a warning message to a user via a display of the hand-held test meter (see step 640 of FIG.).

Once apprised of the present disclosure, one skilled in the art will recognize that methods according to embodiments of the present invention, including method 600, can be readily modified to incorporate any of the techniques, benefits and characteristics of hand-held test meters according to embodiments of the present invention and described herein.

Once apprised of the present disclosure, one skilled in the art will recognize that the meters and methods according to embodiments of the present invention, including method 600, can employ any suitable electrochemical techniques, including those based on Cottrell current measurements, coulometry, amperometry, chronoamperometry, potentiometry, and chronopotentiometry.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that devices and methods within the scope of these claims and their equivalents be covered thereby.

1. A hand-held test meter for use with an analytical test strip in the determination of an analyte in a bodily fluid sample, the hand-held test meter comprising:
a housing;
a strip port connector disposed at least partially within the housing;
a micro-controller disposed in the housing;
a voltage supply disposed in the housing;
a fluid ingress detection circuit block disposed in the housing and including:
at least one paired signal trace and ground trace; and
a ground-reference,
wherein at least a portion of the at least one signal trace and at least a portion of the at least one ground trace are separated by a predetermined distance;
wherein the at least one signal trace is electrically connected to the voltage supply and to the micro-controller;
wherein the ground trace is electrically connected to the ground-reference; and
wherein the in the absence of ingress fluid, the signal trace of the at least one paired signal trace is electrically isolated from the ground trace.

2. The hand-held test meter of claim 1 wherein the fluid ingress detection circuit block further includes at least one resistor, and
wherein the at least one signal trace is electrically connected to the voltage supply via at least one resistor.

3. The hand-held test meter of claim 2 wherein the voltage supply is a 3 Volt (3V) voltage supply and the at least one resistor is a 1 M-ohm resistor.

4. The hand-held test meter of claim 1 wherein the at least one signal trace and ground trace pair is a single signal trace and ground trace pair.

5. The hand-held test meter of claim 4 wherein the single signal trace and ground trace pair is disposed within the housing and around a perimeter of the strip port connector.

6. The hand-held test meter of claim 1 wherein the at least one signal trace and ground trace pair is a plurality of pairs of single signal trace and ground trace pair.

7. The hand-held test meter of claim 1 wherein the voltage supply, fluid ingress detection circuit block, and ground-reference are configured such that a non-zero voltage signal output is generated by the ingress detection circuit block in the absence of fluid ingress.

8. The hand-held test meter of claim 7 wherein the voltage supply, fluid ingress detection circuit block and ground-reference are configured such that an essentially zero voltage signal output is generated by the ingress detection circuit block upon fluid ingress into the housing that creates an electrical short circuit across the paired signal and ground trace.

9. The hand-held test meter of claim 1 wherein the fluid ingress detection circuit block generates an output signal to the micro-controller that is dependent on fluid ingress into the meter housing.

10. The hand-held test meter of claim 9 further including:
a display,
and wherein the hand-held test meter is configured to display a warning message on the display based on the output signal received at the micro-controller from the fluid ingress detection circuit block.

11. The hand-held test meter of claim 1 wherein the analytical test strip is an electrochemical-based analytical test strip configured for the determination of glucose in a whole blood bodily fluid sample and the strip port connector is configured to operatively receive the electrochemical-based analytical test strip.

12. A method for employing a hand-held test meter for use with an analytical test strip in the determination of an analyte in a bodily fluid sample, the method comprising:
activating a fluid ingress detection circuit block disposed within a housing of the hand-held test meter;
employing the fluid ingress detection circuit block of the hand-held test meter to detect the presence of fluid ingress into the housing of the hand-held test meter; and
generating an output signal with the fluid ingress detection circuit block with the output signal being a first predetermined output signal in the absence of fluid ingress and a second predetermined output signal in the presence of ingress fluid, whereby generation of the second predetermined output signal represents detection of ingress fluid.

13. The method of claim 12 wherein the hand-held test meter further comprises:
a strip port connector disposed at least partially within the housing;
a micro-controller disposed in the housing;
a voltage supply disposed in the housing; and
a ground-reference, and
wherein the fluid ingress detection circuit block disposed in the housing and includes:
at least one paired signal trace and ground trace,
wherein at least a portion of the at least one signal trace and at least a portion of the at least one ground trace are separated by a predetermined distance;
wherein the at least one signal trace is electrically connected to the voltage supply and to the micro-controller;
wherein the ground trace is electrically connected to the ground-reference; and
wherein the in the absence of ingress fluid, the signal trace of the at least one paired signal trace is electrically isolated from the ground trace.

14. The method of claim 12 wherein the fluid ingress detection circuit block further includes at least one resistor, and
wherein the at least one signal trace is electrically connected to the voltage supply via the at least one resistor.

15. The method of claim 13 wherein the voltage supply is a 3 Volt (3V) voltage supply and the at least one resistor is a 1 M-ohm resistor.

16. The method of claim 12 wherein the at least one signal trace and ground trace pair is a single signal trace and ground trace pair.

17. The method of claim 16 wherein the single signal trace and ground trace pair is disposed within the housing and around a perimeter of the strip port connector.

18. The method of claim 13 wherein the at least one signal trace and ground trace pair is a plurality of pairs of single signal trace and ground trace pair.

19. The method of claim 13 wherein the voltage supply, fluid ingress detection circuit block, and ground-reference are configured such that a non-zero voltage signal output is generated by the ingress detection circuit block in the absence of fluid ingress.

20. The method of claim 19 wherein the voltage supply, fluid ingress detection circuit block and ground-reference are configured such that an essentially zero voltage signal output is generated by the ingress detection circuit block upon fluid ingress into the housing that creates an electrical short circuit across the paired signal and ground trace.

21.-23. (canceled)
